(19) United States
(12) Patent Application Publication
(10) Pub. No.: US 2013/0048768 A1
(43) Pub. Date: Feb. 28, 2013

(54) BATTERY POWERED FOOD WASTE DISPOSER

(71) Applicant: Thomas R. Berger, Racine, WI (US)

(72) Inventor: Thomas R. Berger, Racine, WI (US)

(73) Assignee: Emerson Electric Co., St. Louis, MO (US)

(21) Appl. No.: 13/400,174

(22) Filed: Feb. 20, 2012

Related U.S. Application Data
(60) Provisional application No. 61/445,596, filed on Feb. 23, 2011.

(51) Int. Cl. B02C 23/36

(52) U.S. Cl. 241/46.013

(57) ABSTRACT

A food waste disposer includes a food conveying section, a motor section and a grind and discharge section. The grind and discharge section is disposed between the food conveying section and the motor section and includes a grind section and a discharge section. The food conveying section conveys food waste to the grind section. The grind section includes a grind mechanism having a stationary grind ring and a rotating shredder plate assembly that rotates within the stationary grind ring to grind food waste. The rotating shredder plate assembly is rotated by a motor of the motor section. The rotating shredder plate assembly includes a shredder plate and one or more lugs. The food waste disposer has a battery coupled to it that provides power to the motor. In an aspect, the battery is a removable, rechargeable battery pack.

### CROSS-REFERENCE TO RELATED APPLICATIONS

This application claims the benefit of U.S. Provisional Application No. 61/445,596, filed on Feb. 23, 2011. The entire disclosure of the above application is incorporated herein by reference.

### FIELD

The present disclosure relates generally to food waste disposers, and more particularly, to a battery powered food waste disposer.

### BACKGROUND

This section provides background information related to the present disclosure, which is not necessarily prior art.

A food waste disposer of the type that is disposed underneath a sink and is mounted to a drain opening of the sink typically includes a food conveying section, a motor section and a grind section. The grind section is disposed between the food conveying section and the motor section. The food conveying section conveys food waste and water to the grind section. The grind section receives and grinds the food waste and the ground food waste is discharged through a discharge opening to a tailpipe.

The grind section typically includes a grind mechanism with a rotating shredder plate assembly and a stationary grind ring. The shredder plate assembly is connected to a shaft of an electric motor of the motor section and includes a shredder plate with one or more lugs, typically one or more pairs of lugs. The lugs may include fixed lugs that are fixed to the shredder plate, rotatable lugs (also called swivel lugs) that are rotatably fastened to the shredder plate and are free to rotate thereon, or both. The shredder plate is rotated relative to the grind ring via the electric motor. The grind ring is typically mounted in a housing and includes multiple spaced teeth.

During operation of the food waste disposer, the food waste that is directed from the food conveying section to the grind section is forced by the lugs against the grind ring to comminute the food waste. When the lugs are swivel lugs, rotation of the shredder plate creates a centrifugal force that acts upon the lugs and enhances comminution of the food waste between the lugs and the grind ring. The sharp edges of the teeth grind the food waste into particulate matter (or ground matter). When the food waste is sufficiently ground, the food waste passes through gaps between the shredder plate and the grind ring and enters a discharge area in an upper end bell as a food waste/water slurry. It is then discharged out a discharge outlet in the upper end bell through a tail pipe to a drain line of household plumbing.

Typically, food waste disposers operate off household power and require access to the household power in the sink cabinet. In a typical installation, the food waste disposer is wired to household power through a wall switch that is used to turn the food waste disposer on and off. Alternatively, when the food waste disposer is a batch feed disposer, the wall switch can be replaced by an activation means located in the stopper used with the batch feed disposer. In another alternative, an air switch mounted on the sink deck or countertop, or wireless remote control, can be used instead of the wall switch to turn the food waste disposer on and off. However, these alternatives still require a connection to household power in the sink cabinet.

### SUMMARY

A food waste disposer includes a food conveying section, a motor section and a grind and discharge section. The grind and discharge section is disposed between the food conveying section and the motor section and includes a grind section and a discharge section. The food conveying section conveys food waste to the grind section. The grind section includes a grind mechanism having a stationary grind ring and a rotating shredder plate assembly that rotates within the stationary grind ring to grind food waste. The rotating shredder plate assembly is rotated by a motor of the motor section. The rotating shredder plate assembly includes a shredder plate and one or more lugs. The food waste disposer has a battery coupled to it that provides power to the motor.

In an aspect, the battery is a removable, rechargeable battery pack.

### BRIEF DESCRIPTION OF THE DRAWINGS

Other objects and advantages of the invention will become apparent upon reading the following detailed description and upon reference to the drawings in which:

FIG. 1 is a sectional view of a battery powered food waste disposer in accordance with an aspect of the present disclosure; and

FIG. 2 is a simplified schematic of an example control circuit for the food waste disposer of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention.

### DETAILED DESCRIPTION

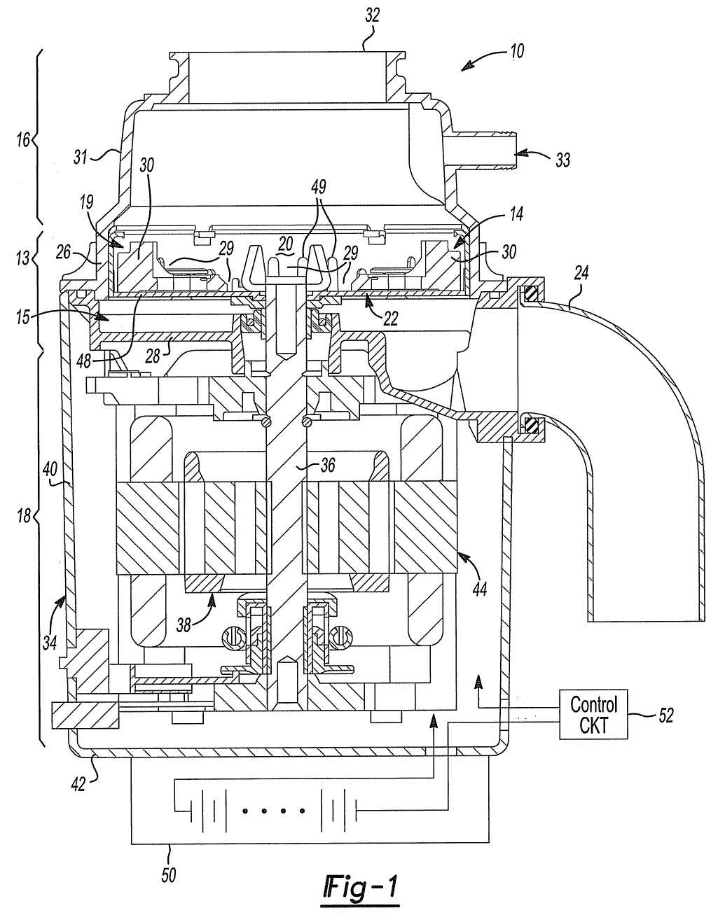

In FIG. 1, a food waste disposer 10 is shown. The food waste disposer 10 includes a grind and discharge section 13 disposed between a food conveying section 16 and a motor section 18. The grind and discharge section 13 includes a grind section 14 and a discharge section 15. The grind section 14 includes a grind mechanism 19 with a stationary grind ring 20 and a rotating shredder plate assembly 22. The shredder plate assembly includes a shredder plate 48 on which lugs 30 are rotatably fastened. Lugs 30 are illustratively swivel lugs, but it should be understood that they could be fixed lugs, or include both swivel lugs and fixed lugs.

The grind section 14 includes a grind housing 26 that encompasses the grind mechanism 19. The grind housing 26 may be fastened to an upper end bell (UEB) 28 of the discharge section 15 and holds the grind ring 20. The grind ring 20 is mounted in a fixed (stationary) position within the grind housing 26. The grind ring 20 includes teeth 29. The grind ring 20 may be fixedly affixed to an inner surface of the grind housing 26 by an interference fit and may be composed, for example, of galvanized steel.

The food conveying section 16 includes an inlet housing 31 with a first inlet 32. The first inlet 32 receives food waste and water. The inlet housing 31 may be a metal housing or an injection molded plastic housing. The inlet housing 31 also includes a second inlet 33 for receiving water discharged from a dishwasher (not shown). The inlet housing 31 may be integrally formed with the grind housing 26, such as by injection-molding both of the housings 26, 31 as a single component.

The motor section 18 includes a motor 34 having a rotor 38 and a stator 44. Rotor 38 rotates in stator 44 imparting rotational movement to a rotor shaft 36 of a rotor 38. Motor 34 is illustratively a direct current motor. By way of example, motor 34 may be a permanent magnet DC motor, a brushless DC motor, or a universal motor. The motor 34 is enclosed within a motor housing 40. The motor housing 40 has a frame 42. The rotor shaft 36 is connected to and rotates the shredder plate assembly 22 within the grind ring 20.

A battery 50 is coupled to food waste disposer 10 to provide power to motor 34. Battery 50 is illustratively coupled to motor 34 through control circuit 52. Battery 50 may be by way of example a removable battery pack, and may illustratively be a rechargeable battery pack.

A battery operated food waste disposer in accordance with the above aspect would not require access to household power and could be installed in sinks where there is no household power available under the sink. By using a removable, rechargeable battery pack for battery 50, one such battery pack can be used to power food waste disposer 10 while another such battery pack is being recharged.

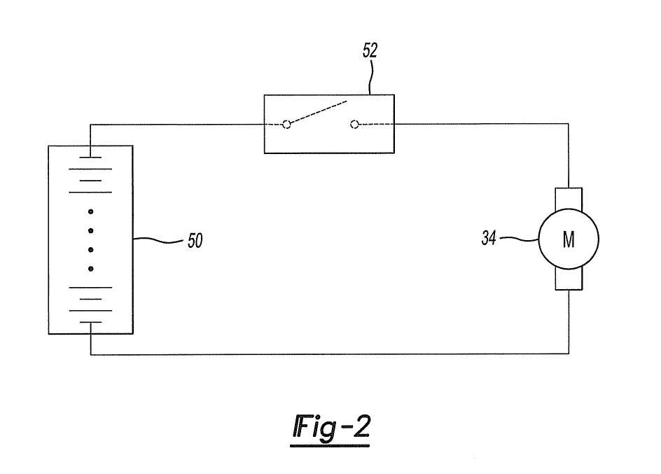

FIG. 2 is a simplified schematic of control circuit 52 that couples battery 50 to motor 34. Control circuit 52 may simply be a switch, such as an air switch. Control circuit 52 may also be a remotely controlled switching circuit activated by a remote controller (not shown), such as a wireless remote controller.

During operation of the food waste disposer 10, the shredder plate assembly 22 is rotated by motor 34. Due to the rotation of the shredder plate assembly 22, lugs 30 force the food waste against the teeth 29 of grind ring 20 to grind the food waste into small particulate matter. A slurry of the particulate matter and water passes from the shredder plate assembly 22, outside a periphery of shredder plate 48, through gaps 49 between the teeth 29 to a discharge area below the shredder plate assembly 22 and in the UEB 28. It is then discharged out a discharge outlet of UEB 28 through tailpipe 24 to a drain line (not shown).

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. A food waste disposer comprising:
a food conveying section, a motor section and a grind and discharge section, the grind and discharge section disposed between the food conveying section and the motor section, the food conveying section conveying food waste to a grind section of the grind and discharge section;
the grind section including a grind mechanism, the grind mechanism including a stationary grind ring and a rotating shredder plate assembly that rotates within the stationary grind ring to grind food waste, the rotating shredder plate rotated by a motor of the motor section;
the rotating shredder plate assembly includes a shredder plate and one or more lugs; and
a battery coupled to the food waste disposer that provides power to the motor.

2. The food waste disposer of claim 1 wherein the battery is a removable, rechargeable battery pack.

3. The food waste disposer of claim 1 wherein the one or more lugs are swivel lugs rotatably fastened to the shredder plate.

4. The food waste disposer of claim 1 wherein the discharge section includes an upper end bell and the grind section includes a grind housing that encompasses the grind mechanism and is fastened to the upper end bell.

5. The food waste disposer of claim 4 wherein the food conveying section includes an inlet housing having a first inlet that through which food waste and water is received and a second dishwasher inlet.
